(19) United States
(12) Patent Application Publication
(10) Pub. No.: US 2022/0007615 A1
(43) Pub. Date: Jan. 13, 2022

(54) Toroidal Retrievable Pet Toy

(71) Applicant: Shaun William Hargadine, Tampa, FL (US)

(72) Inventor: Shaun William Hargadine, Tampa, FL (US)

(21) Appl. No.: 17/168,120

(22) Filed: Feb. 4, 2021

Related U.S. Application Data
(60) Provisional application No. 62/970,660, filed on Feb. 5, 2020.

(51) Int. Cl. A01K 15/02

(52) U.S. Cl. CPC A01K 15/025

(57) ABSTRACT

A rollable pet toy in the shape of a ring or toroid containing raised portions on both an inner and outer surface to distribute mass for centrifugal effects and to directional stability when rolling along a surface.

This application claims the benefit of priority to the provisional application No. 62/970,660, filed Feb. 5, 2020, entitled “Toroidal Retreivable Pet Toy,” the entire contents of which are hereby incorporated herein by reference.

This application includes material which is subject to copyright protection. The copyright owner has no objection to the facsimile reproduction by anyone performing work with regard to the patent disclosure, as it appears in the Patent and Trademark Office files or records, but otherwise reserves all copyright rights whatsoever.

### BACKGROUND

### Field of the Invention

This invention generally relates to pet toys and in particular to a throwable or rollable toy to be used by humans in throwing games with animals, particularly with dogs.

### Description of the Prior Art

It is well known that animals, such as dogs and cats, love to chase anything that moves. Pet toys have been developed to engage pets in this behavior, especially with dogs. Many dog trainers and breeders believe engaging this behavior is a healthy and beneficial exercise for a dog. Specifically, retrieving, or the common game of “fetch,” where a dog furiously and happily races after a thrown object. These objects come in various forms, such as balls, flying discs, ropes and many others.

Generally, the objects provide two forms of retrieval, static and active. A static retrieval is what is expected from an object such as a length of rope or stick that is thrown, and comes to a stop before the dog picks it up to return it. An active retrieval is one where the object is still moving or in motion when the dog retrieves it. A flying disc caught in flight, or a ball seized while still rolling are examples of active retrievals. Most retrievals begin as attempts at active retrievals, but whether the toy is stopped or still in motion when the dog engages it is often determined by the distance and speed of a throw or launch. An easy example is a ball thrown that comes to a stop and remains stationary before a dog retrieves it. In this example, the throwers intent may have been an active retrieval, but due to factors such as distance, speed, object size and pet attentiveness, the ball was not retrieved before its motion ended, and it came to rest.

Generally, active retrieval is more enjoyable for both the dog and the thrower. Active retrieval allows a dog to essentially “chase down” a moving object and seize it while it is still in motion. This is a more natural behavior that mimics chasing prey. It is also more challenging and requires more focus from the dog to succeed in this type of retrieval.

Currently, active retrievals are most successful using flying discs. Other versions may be successful, such as throwing tennis ball in such a manner that it bounces high and remains in motion long enough for the dog to identify it and race to retrieve it. Flying discs operate in the same manner, by remaining aloft and in flight long enough for the dog to identify the disc and run to catch it before it falls to the ground. However, these type of retrievals are limited by the location in which they are attempted. For example, in a backyard with a limited area, sufficient distance may not be available to allow a flying disc to remain aloft long enough for a dog to recognize it, chase it, and catch it while it is still moving through the air. The same limitations apply to a retrieval of a thrown tennis ball. This is often especially true when taking place in a location with grass, such as a typical lawn, which acts to quickly stall a ball's momentum. By throwing a ball in a manner which causes it to bounce a sufficient height can reduce limitation somewhat, but also requires a location with a hard enough surface to allow bouncing of sufficient height and duration, and use of a ball or object with physical properties conducive to bouncing.

Further limitations exist as well in the currently available options. For example, flying discs are naturally of a shape that creates difficulties for a dog to pick up once the disc has fallen to the ground. Equally, their generally flat shape makes it difficult for a dog to reliably latch onto them while still in flight. This includes such well-known flying discs such as the trademarked “FRISBEE” by the Wham-o-Corp. of San Gabriel, Calif., the assignee of U.S. Pat. No. 3,724,122, issued Apr. 3, 1973.

A dog, like many other animals, lacks opposable thumbs. As a result, dogs generally carry items by grasping them in their jaws. In most situations, this method of grasping is adequate. However, because of the configuration of conventional flying discs, when the disc is lying stationary, flat and upon the ground it is difficult for the animal to pick up the disc due to a lack of surface features for a dog to grip between its upper and lower jaws. This can lead a dog frantincally pawing at this disc in an effort to flip it up, or the dog often leaves the disc without retrieving it. This causes inconvenience to the thrower, who then has to retrieve it themselves, making the game of fetch less enjoyable for both the thrower and the dog. When a disc shaped as the above-mentioned Frisbee lands with its underside facing upwardly, the dog can get a grip thereon with his teeth due to a brim running along the periphery of the Frisbee perpendicular to its flat plane. Further, a water retrieval does not have these specific limitations as water retrievals by their nature are passive retrievals, but the shape of a disc poses limitations that act to impair a dogs breathing due to how a wide, flat shape fills a dog's mouth and inhibits breathing while swimming with the disc held in its teeth.

Balls, such as the common tennis ball, have additional limitations as well. While balls are generally easier for a dog to pick up off the ground than a disc, balls have the limitation that they are often difficult to remove from a dog's mouth in the instances where a dog doesn't want to release it, or wants to engage in a game of tug 'o war. Further, a ball has even more severe limitations in a water environment, as the shape of a ball effectively blocks a dog's airway when holding a ball in its mouth while trying to swim. The spherical shape of a ball tends to fill a dog's mouth to the point where air flow is impaired.

Hence, those concerned with the development of pet toys have long recognized the need for retrievable toys, such as balls and flying saucers, which are easy to grasp while lying on the ground, or in the water, and do not impeded a dog's ability to breath.

These limitations result in few opportunitys for a fully active retrieval for a dog when playing fetch. What is needed is a new type of pet toy that provides opportunities for active retrievals not limited by distance or surface properties. Additionally, there is need for a toy that provides a safer and convenient grasping option for a dog, both on the ground, in the air and in the water. The present invention provides for all of these needs.

### BRIEF DESCRIPTION

Briefly, in general terms, the present invention provides a new and improved throwable and rollable toy for easier, safer, and more active retrieval by a dog. While a dog is generally the species of pet that is most commonly associated with a game of “fetch,” the terms dog and pet may be used interchangeably herein, and are also understood to mean any species of animal that may be kept as a pet and trained to play retrieval games such as “fetch.”

Basically, the present invention is directed to a new and improved throwable and rollable pet toy fabricated as a single solitary structure. The structure is generally the shape of a torus. This shape may also be referred to as toroidal. The toroidal shape is a unique profile revolved 360 degrees. The profile consists generally of an outer surface and inner surface. The outer surface contains two elevated portions, or ridges, with a valley or depression between them. The inner surface generally consists of a centered ridge. The toroid has an overall diameter, and a profile diameter; the profile diameter being less than 50% of the overall diameter. This allows for a mass distribution along the periphery of the toroid that functions to maintain momentum . The outer surface functions to provide tracking properties so that the toy can roll in a straight line. Additionally, the profile, including the outer surface and inner surface, provides a shape that allows a dog to easily grasp the toy with its teeth, but also limits the strength of dog's grip, so that the toy can be removed easily from the dog's mouth. The overall profile functions to direct the mass distribution to the periphery, which is generally the outersurface of the profile. Also, the profile provides a shape that enables an convenient grip for throwing or rolling, such that a thumb or finger can lay in the valley or depression between the two ridges on the outer surface and guide a throw or roll by a human user.

These and other objects and advantages of the invention will become apparent from the following more detailed description, when taken in conjunction with the accompanying drawings of the illustrative and exemplary embodiments.

### BRIEF DESCRIPTION OF THE DRAWINGS

FIG. 1 is a perspective view of an exemplary embodiment of a retrievable pet toy of the present invention;

FIG. 2 is an alternate perspective view of an exemplary embodiment of a retrievable pet toy of FIG. 1;

FIG. 3 is a perspective cross sectional view, illustrating the cross sectional profile of an exemplary embodiment of a retrievable pet toy of FIG. 1;

FIG. 4 is a perspective cross sectional view and cross sectional profile of an alternate exemplary embodiment of a retrievable pet toy of the present invention;

FIG. 5 is a perspective cross sectional view and profile of an alternate exemplary embodiment of a retrievable pet toy of the present invention;

FIG. 6 is a perspective cross sectional view of an alternate exemplary embodiment of a retrievable pet toy of the present invention;

### DETAILED DESCRIPTION

Referring to the accompanying drawings for the purposes of illustration, a retrievalable pet toy of the present invention, generally designated 100, is configured in a toroidal shape. For the purposes of this description, a toroid may be considered as a ring-like shape and have two radii, a major radii, that which is representative of the overall diameter of the shape, or ring, and a minor radii, that which is represented by a diameter of a cross section of the mass of the ring. Generally, the minor radius can never be larger than the major radius. This definition of a toroid is for reference within this written description, and should not be construed to limit any of the described embodiments of the present invention. One skilled in the art will readily identify and appreciate the nature of a toroidal shape, without limitation from the provided definition. For purposes of this specification, the outer diameter and major radius may be used interchangeably throughout. Similarly, the profile diameter and minor radius may be used interchangeably throughout.

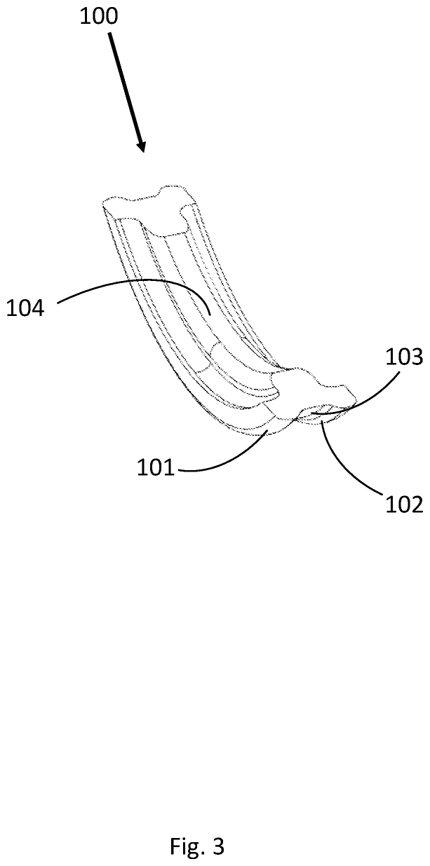

The retrievable toy of the present invention generally comprises a profile along the or co-planar with the minor radius. The profile modifies the shape of the circle normally defined by the minor radius in a toroid. For example, and without limitation, an illustrative profile may be the shape of a triangle perpendicular to the plane of the major radius, where the entire shape would appear to be a triangle revolved into a circle 360 degrees with no termination points. An exemplary embodiment of a profile is illustrated in cross sectional view in FIG. 3.

The profile of the minor radius of the present invention, in some exemplary embodiments, is defined in a shape to facilitate mass distribution, thereby providing centrifugal affects during the rotation, or rolling of the toy. The profile facilitates this function by distributing the bulk of the mass to the outer portion of the profile. The profile further is shaped to direct surface pressure during rotation across, or rolling across a surface. The design restricts surface contact, and therefore, surface pressure, to two defined areas, or ridges, running along the outer circumference of the toroid. The profile further functions to provide stabilization during rotation or rolling, by concentrating the remaining mass on the inner portion of the circumference into what may be termed the center of the profile.

The entirety of the shape of the profile further functions to allow for an adequate grip by a pet's jaw, without allowing the pet to get such a strong grip that the toy is difficult to remove from the pet's bite. The profile provides safe angles that protect the pet's teeth, and also prevents a pet from getting a strong bite by its back teeth. When a dog seeks to chew on something hard, the back teeth are often used. The profile of the present invention prevents a pet, such as a dog, from easily chewing on the toy with its back teeth, which will ensure the toy stays intact much longer because a dog cannot chew it to pieces nearly as quickly without being able to use its back teeth. An exemplary profile of the present invention is illustrated by FIG. 3.

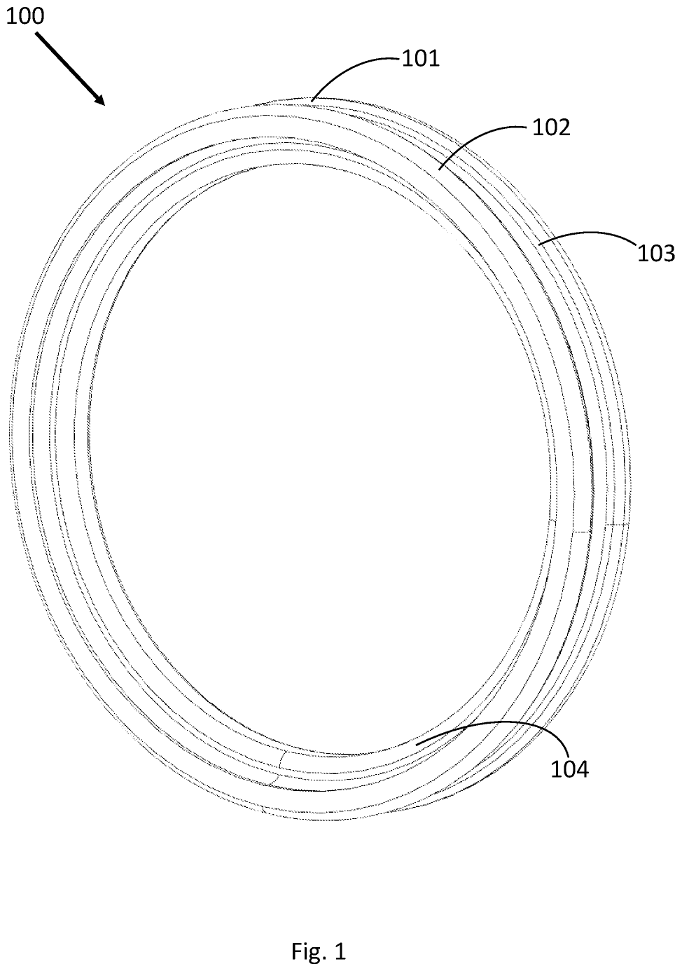

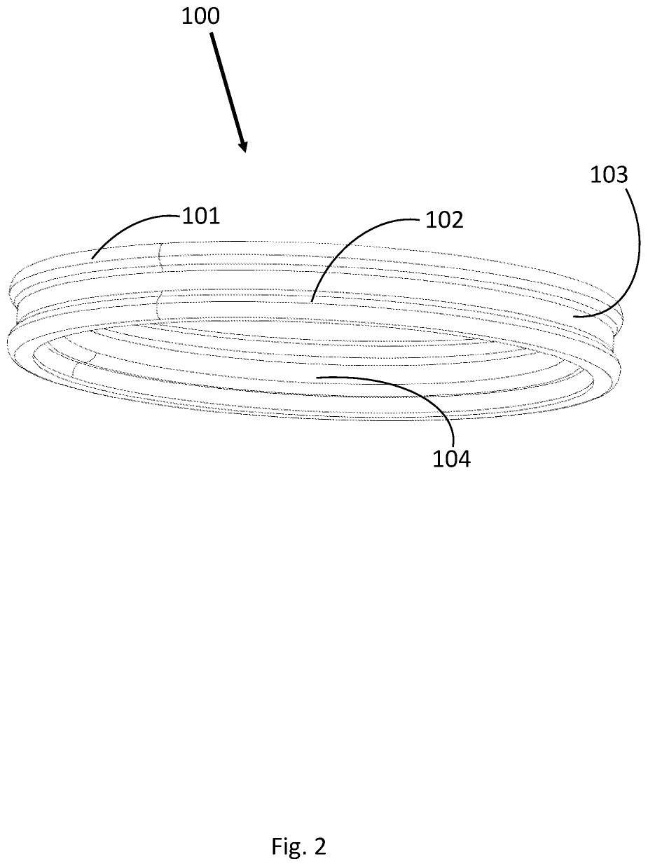

Referring now to FIGS. 1-3, an exemplary retrievable pet toy of the present invention is depicted. The toy 100 comprises a toroidal shape, with an inner and outer portion. The inner and outer portion define a profile, or a shape. The outer portion of the profile comprises a first ridge 101 and a second ridge 102, running parallel to each other along the outer circumference of the toy. Ridges 101 and 102 are generally positioned to distribute the mass of the profile to the outermost portion, and to direct surface contact and pressure. The interior sides of ridges 101 and 102 slope downward toward a valley 103, or a lower portion. On the inner circumference of toy, a beam 104 is positioned generally centered on the origin of the minor radius or profile diameter.

In an exemplary preferred embodiment, and without limitation, the overall diameter of the toy may be between 300 mm and 200 mm, and the diameter of the profile may be between 20 mm and 50 mm. In some preferable exemplary embodiments, the diameter of the profile may be between 10% and 20% of the overall diameter. Further, in some preferred exemplarily embodiments, and without limitation, ridges 101 and 102 may be between 3 mm and 9 mm in height, and between 5 mm and 10 mm in width at their widest point. The top of ridges 101 and 102 may, in some exemplary embodiments, have a rounded shape on both sides of each ridge. Beam 104 may, in some exemplary embodiments be between 5 mm and 20 mm in width, and between 3 mm and 10 mm in length. One skilled in the art will appreciate from the FIGS. 1-3 that the top portions of ridges 101 and 102, as well as the bottom portions of beam 104 are configured in a rounded shape. In some exemplary embodiments, the rounded aspects of the edges of the various features on toy 100, may operate to prevent the teeth of a dog, or pet, from remaining in a single spot while the dog or pet applies pressure with its jaw. The sloping nature of the profile as one feature transitions to another may allow teeth to slide, thereby preventing the firm grip by said teeth. The failure to obtain a strong grip by the sliding of the teeth may, in some embodiments, encourage the dog, or pet, to continue trying to adjust the grip of their teeth on the toy, giving a pet owner an opportunity to extract the toy from the pets mouth with little effort. The lack of a strong grip may also discourage a dog or pet to resist releasing the toy to the owner.

In an exemplary preferred embodiment of the present invention, toy 100 may be a single piece of material, such as a plastic. In some exemplary embodiments, the toy may be conveniently made of a material which has anti-fungus and anti-microbial microbial properties. One such material is expanded polypropylene (EPP), available through injection molding techniques manufactured by ARPRO, which has offices at 1443 E. 12 Mile Road, Crown Office Village, Building J, Madison Heights, Mich. 48071. The EPP material is merely one exemplary embodiment. Other suitable materials which may or may not have anti-fungal or anti-microbial exist, such as plastics, including, without limitation, High-density polyethylene (HDPE), Polyvinyl chloride (PVC), Low-density polyethylene (LDPE), Polypropylene (PP), Polystyrene (PS), High impact polystyrene (HIPS), Polyamides (PA), (Nylons), Acrylonitrile butadiene styrene (ABS), Polycarbonate (PC), Polycarbonate/Acrylonitrile Butadiene Styrene (PC/ABS), Polyurethanes (PU) and Poly(methyl methacrylate) (PMMA). In some embodiments, the toy may also be constructed of metals, such as, without limitation, aluminum or tin, or various woods.

In one exemplary embodiment, the toy may be made of a material that includes an anti-microbial additive, such as Ultra-Fresh, developed by Thomson Research Associates, located at 49 Gervais Drive, Toronto, Ontario, M3C1Y9, Canada. Many other suitable materials which are capable of providing the required structural strength and are capable of having an anti-microbial additive exist in the art and would be readily apparent to one skilled in the art to fall within the scope of present invention.

Another exemplary material that the toy may be constructed of, is a polyurethane. If polyurethane is used, the preferred type is described in more detail in U.S. patent application Ser. No. 908,220, filed Sep. 17, 1986, which is hereby incorporated by reference in its entirety. The preferred type of polyurethane is a polyester polyurethane and, more particularly, the reaction product of a polycarboxylic acid such as adipic acid and a polyfunctional isocyanate such as methylene diphenyl diisocyanate. A very desirable material is a polyurethane elastomer sold by the Dow Chemical Company under the trademark “PELLETHANE” and particularly the polyurethane having the product identification of “PELLETHANE 2355-75A”. This latter product is the reaction product of adipic acid and methylene diphenyl diisocyanate. It has excellent flexibility for chewing and yet has sufficient strength and toughness so that the material can withstand highly active mastication thereof by large animals.

In a number of exemplary embodiments, the toy may be fabricated or manufactured with many techniques such as, without limitation, thermoforms, injection molding, milling and machining, blow forming, simple molding, or even hand crafted. One skilled in the art will appreciate and understand that embodiments of the present invention could be manufactured in any number of techniques or processes for forming single shapes, specifically without limitation, single shapes out of plastic-like materials. In some embodiments, additive manufacturing techniques may be preferable, such as, without limitation, 3d printing.

While in a preferred embodiment, the toy of the present invention may be manufactured as a single piece, in some embodiments, that single piece may not be solid. While the cross section view in FIG. 3 illustrates a full solid piece of material, in some embodiments, only the outer portions of toy may be solid. For example, where a 3d printing technique is used, the single piece may comprise a solid outer shell, such as, without limitation, a solid outer shell of 2 mm to 5 mm with an infill between 10% and 25%. Having a non-solid inner portion of the toy may provide for other advantageous properties, such as increased buoyancy in water, flexibility, lighter weight, or overall less material required when manufacturing. Some of the additional Figs and photographs included with this provisional provide non-limiting examples of various infills or embodiments of the inner portion of the profile.

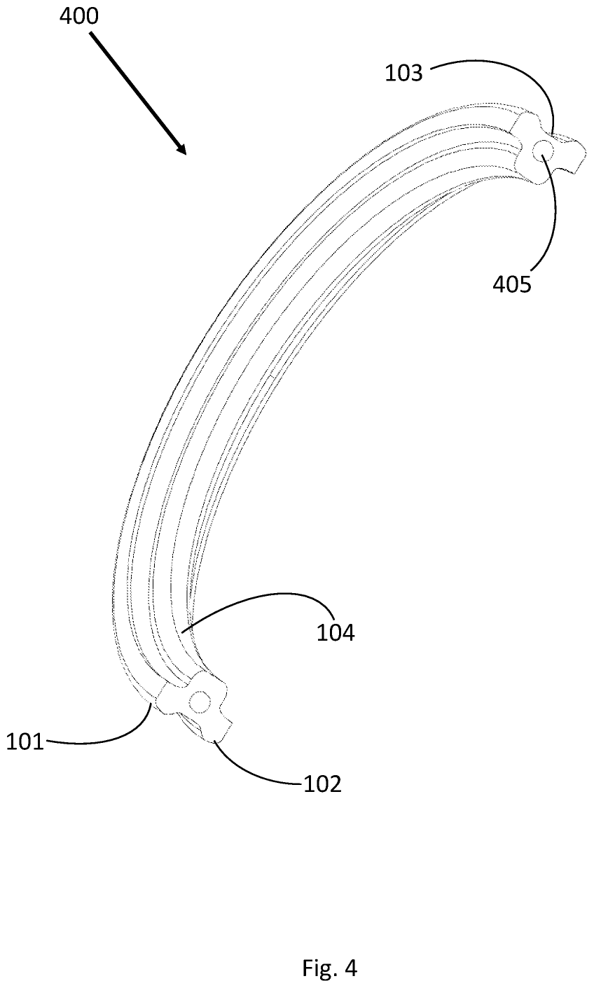

For example, referring now to FIG. 4, an exemplary embodiment of the toy 400 of the present invention is illustrated with a hollow tube 405 positioned generally centered within the profile diameter. Ridges 401 and 402, are similar to ridges 101 and 102 from FIGS. 1-3. Similarly, valley 403 is similar to valley 103, and beam 404 is similar to beam 104 from FIGS. 1-3. A hollow tube such as hollow tube 405 may without limitation, in some exemplary embodiments, reduce the mass and weight of the toy, provide additional buoyancy, and provide for flexibility in the overall shape and act to distribute the mass more decisively to ridges 401 and 402, and beam 405.

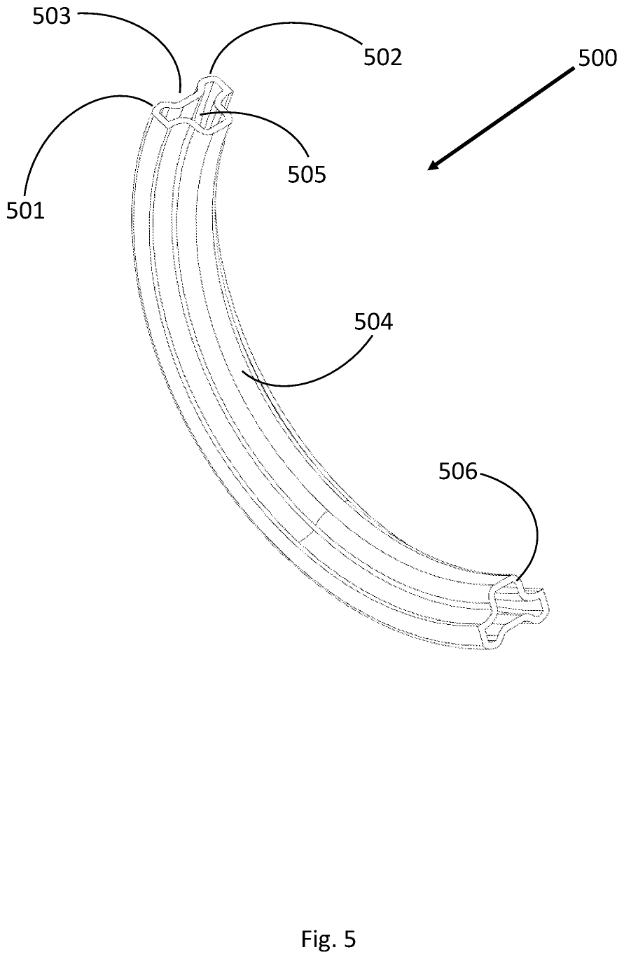

Referring now to FIG. 5, an exemplary embodiment of the toy 500 of the present invention is illustrated in cross-sectional view with a hollow interior 505. Ridges 501 and 502, with valley 503 are similar in shape and function to ridges 101 and 102, with valley 103 from FIGS. 1-3. Beam 504 is similarly analogous in shape and function to beam 104 in FIGS. 1-3. In this exemplary embodiment, a toy 500 comprises cavity 505. The shell 506 of material which forms the rest of the profile may, in some exemplary embodiments, be between 2 mm and 5 mm thick. The configurate of shell 506 and cavity 505 may without limitation, in some exemplary embodiments, reduce the mass and weight of the toy, provide additional buoyancy, and provide for flexibility in the overall shape and act to distribute the mass more decisively to the upper portion of the profile.

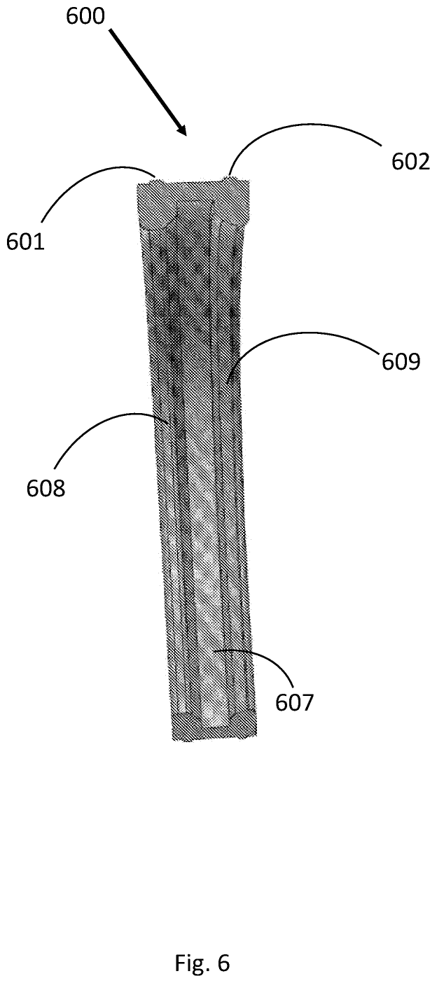

In some preferred embodiments, the profile may be adapted to provide a channel on the interior instead of a beam. Referring now to FIG. 6, an alternate exemplary embodiment of the present invention is illustrated in toy 600. In this embodiment, ridges 601 and 602 are positioned in parallel on outer surface similar in nature to ridges 101 and 102 from FIG. 1.

1. A pet toy comprising:
A singular body having a generally toroidal shape,
said body comprising,
a first outer ridge,
a second outer ridge generally parallel to said first outer ridge,
an outer valley positioned between said first outer ridge and said second outer ridge,
and an inner beam, positioned opposite of said outer valley, wherein said outer ridges, valley, and inner beam run parallel to each other and the circumference of the major radius of the toroid.

2. A retrievable pet toy comprising a single piece of material in a generally torus shape,
said torus shape having an inner side and an outer side,
said inner side comprising a beam portion protruding toward the center of said torus shape, and running parallel to the major circumference of the torus shape,
said outer side comprising at least two parallel ridges protruding outward from the center of said torus shape, and running parallel to the major circumference of the torus shape,
said outer side further comprising a recessed portion between said parallel ridges, said recessed portion running parallel to the major circumference of the torus shape and parallel to said ridges,
wherein said beam, ridges, and recessed portion are all formed in a single profile within the minor circumference of the torus shape.

3. A retrievable pet toy comprising a single piece of material in a generally ring shape,
said ring shape having an inner side and an outer side, said inner side comprising a beam portion protruding toward the center of said ring shape, and running parallel to the major circumference of the ring shape,
said outer side comprising at least two parallel ridges protruding outward from the center of said ring shape, and running parallel to the major circumference of the ring shape,
said outer side further comprising a recessed portion between said parallel ridges, running parallel to the major circumference of the ring shape and parallel to said ridges,
wherein said beam, ridges, and recessed portion are all formed in a single profile within the minor circumference of the ring shape.

4. A retrievable pet toy comprising a toroidal shape,
said toroidal shape having an inner surface and an outer surface, said inner surface comprising an inner raised portion protruding toward the center of said toroidal shape from said inner surface, said inner raised portion running parallel to the major circumference of the toroidal shape, and,
said outer surface comprising at least two parallel ridges protruding outward from said outer surface, said at least two parallel ridges running parallel to the major circumference of the toroidal shape.

5. The toy of any previous claim wherein said toy is comprised of a flexible plastic.

6. The toy of any previous claim wherein said toy is comprised of a plastic with an antimicrobial additive.

7. The toy of any previous claim wherein said shape comprises at least one hollow portion positioned parallel to the major circumference of the shape.
